(19) United States
(12) Patent Application Publication
(10) Pub. No.: US 2010/0120575 A1
(43) Pub. Date: May 13, 2010

(54) TRANSMISSION

(75) Inventor: Walter Muller, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/524,773

(22) PCT Filed: Jan. 8, 2008
(86) PCT No.: PCT/EP2008/050103

§ 371 Date: Jul. 28, 2009

(30) Foreign Application Priority Data
Feb. 8, 2007 (DE) 10 2007 006 228.3

(51) Int. Cl. F16H 57/08; F16H 57/00

(52) U.S. Cl. 475/347; 74/473.29

(57) ABSTRACT

A transmission with a housing (13, 13′, 33) having at least two shafts (1, 2) for adjusting a desired gear ratio. The two shafts (1, 2) communicate with each other by a gearwheel set (5) and are deposed in the housing (13, 13′, 33) by bearing brackets (7, 8). The bearing brackets (7, 8) are deposed on the housing by way of at least one damping element (17) for damping noise and vibration. A shifting device that adjusts the gear ratio is affixed to at least one of the bearing brackets (7, 8) which is decoupled from the housing (13, 13′, 33).

This application is a National Stage completion of PCT/EP2008/050103 filed Jan. 8, 2008, which claims priority from German patent application serial no. 10 2007 006 228.3 filed Feb. 8, 2007.

### FIELD OF THE INVENTION

The invention relates to a transmission of the type explained.

### BACKGROUND OF THE INVENTION

A transmission with a housing is known from the patent document DE 195 02 560 A1 in which two relatively rotatable gearwheels are arranged. The two gearwheels engage, whereby the respective shafts of the gearwheels are mounted with one end in an output-side bearing bracket and the other end in an output-side bearing bracket. The two bearing brackets are separated from the transmission housing by means of an elastic spring ring.

A similar embodiment is also known from the patent document GB 814,724. In this embodiment as well, the shafts which are provided with gearwheels are also mounted respectively in bearing brackets, wherein decoupling of the shaft ends is provided for by means of ring-shaped rubber elements.

It has been demonstrated that in the known transmissions the provided means for decoupling is not sufficient to reduce sound or, as the case may be, noise and vibration transmission.

### SUMMARY OF THE INVENTION

The object of the present invention is therefore to propose a transmission of the type initially described by means of which a complete elimination of sound and vibration transmission to the transmission housing can be realized.

Accordingly, a transmission with a housing is proposed in which at least two shafts for adjusting a desired gear ratio can be coupled to each other, wherein the shafts are mounted in the housing by means of bearing brackets, and wherein the bearing brackets are mounted on the housing by means of at least one damping element for damping sound and vibration. Inventively, a shifting device adjusting the gear ratio is affixed to at least one of the bearing brackets.

In this way, the noise and vibration produced by the shifting device, for example by the gearwheel sets, is not transmitted to the housing either, because the shifting device, independently of its design in any given instance, is affixed to or, as the case may be, supported by the already decoupled bearing brackets.

In a particularly advantageous embodiment of the invention with a shifting device that incorporates an actuating rod for operating shift forks, each end of the actuating rod is movably mounted on the respectively associated bearing bracket. Consequently, the gear ratio desired at any given time can be achieved through actuation of the shift forks without transmitting the resulting noise and vibration to the housing. Furthermore, the effects of thermal expansion can be prevented because of the same thermal expansion coefficients with respect to the position of the main shaft in the shifting device.

In another embodiment of the shifting device in which the shifting device comprises a plurality of selector rails for actuating shift levers, each end of the shift rails can be displaceably mounted on the assigned bearing bracket. Therefore, here too, there is decoupling from the housing via the bearing brackets.

In order to also advantageously absorb axial forces by means of the two bearing brackets, the two bearing brackets can be connected to the shafts in an axial direction via at least one connecting element or similar device. In this way longitudinal extension between the shafts made of steel and the aluminum housing can be prevented, in particular, in the case of housings comprised of aluminum compounds. As a result, different primary tensions on the bearings of the shafts can be avoided. In addition, due to the elastic coupling between the bearings of the shafts and the housing, load alternation in all axial directions which can lead to axial displacement can be prevented. Round rods or discs, or similar elements, can be used as connecting elements.

It has been demonstrated that with a shifting device having shift rails and shift levers, it is an advantage if the bearing brackets are connected via a disc. In this way, the levers of the shifting device can be displaceably mounted on the disc, so that they can also be decoupled from the housing. The levers can preferably be mounted by means of a bolt that is provided as a swiveling axis which is connected to the disc. The bolt used can preferably be designed as a hexagon screw or something similar, which is screwed into a corresponding threaded hole of the disc that forms the connecting element. Other types of fastening means can, however, also be used, such as welds, rivets, or similar, so the connection specified is only an example.

In order to adjust the shaft bearing, for example, in order to allow for a tapered roller bearing, it is particularly advantageous if the selected connecting elements can be longitudinally adjusted. When round rods are used as connecting elements, they can be attached with their respective ends inside recesses of the housing that are lined with the damping element or similar. Other types of attachment are also conceivable.

One possible example of this invention can be designed as a countershaft transmission. The countershaft transmission has a transmission input shaft, a countershaft, and a main shaft, as well as a transmission output shaft, which are coupled to each other via a gearwheel set. The transmission input shafts, the countershaft, and the main shaft, along with the associated shifting device, are mounted above the decoupled bearing bracket inside the housing. In addition, the shifting device which is normally adjacent to the transmission input shaft and the main shaft is attached in to one end of the two bearing brackets respectively, in order to realize the previously described complete decoupling between the gearwheel set of the countershaft transmission and the housing. Other applications are also conceivable, as, for example, in transmissions that are differently configured.

If, for example, the transmission features an additional range group on the transmission output shaft, as is common in so-called range transmissions, it can be provided, in accordance with another advantageous embodiment of the invention, for the transmission output shaft with the coupled range group to be decoupled from the housing by means of at least one additional damping member or similar component for the purpose of damping noise and vibration.

In this way, not only noise transmission from the gearwheel set of the countershaft transmission is decoupled, but also noise transmission from the range group, i.e. from the planetary transmission to the housing, is prevented. In this way, an overall concept for noise reduction for a transmission is attainable.

In the context of an additional embodiment of the invention, a support point for the so-called GP reaction of the range group and a bearing carrier of the transmission output shaft can be attached to a damping element on the housing for the purpose of decoupling the range group. As a support point, a clutch body of the GP reaction is provided which, together with the bearing carrier, can be affixed in the simplest possible manner via a retaining bolt inside a recess of the housing. For example, the recess can be lined with the damping element. Other means of attaching the clutch body and the bearing carrier to the housing are also conceivable for the purpose of decoupling. In employing them, however, it is essential that the damping element be interposed in some manner along the transmission path, in order to realize complete decoupling of the transmission output shaft with the range group and the housing.

### BRIEF DESCRIPTION OF THE DRAWINGS

The invention will be explained in more below on the basis of the drawings.

They show:

FIG. 1 A schematic, cross-sectional, partial view of the housing of an inventive transmission with a shifting device comprising shift forks which is arranged inside the housing in such a way as to reduce noise and vibration;

FIG. 2 A schematic, cross-sectional partial view of an inventive transmission with a shifting device comprising shift rails which is arranged inside the housing in such a way as to reduce noise and vibration; and

FIG. 3 A schematic, partially cross-sectional view of an output-side bearing of the inventive transmission with a range group that is arranged in such as way as to reduce noise and vibration.

### DETAILED DESCRIPTION OF THE DRAWINGS

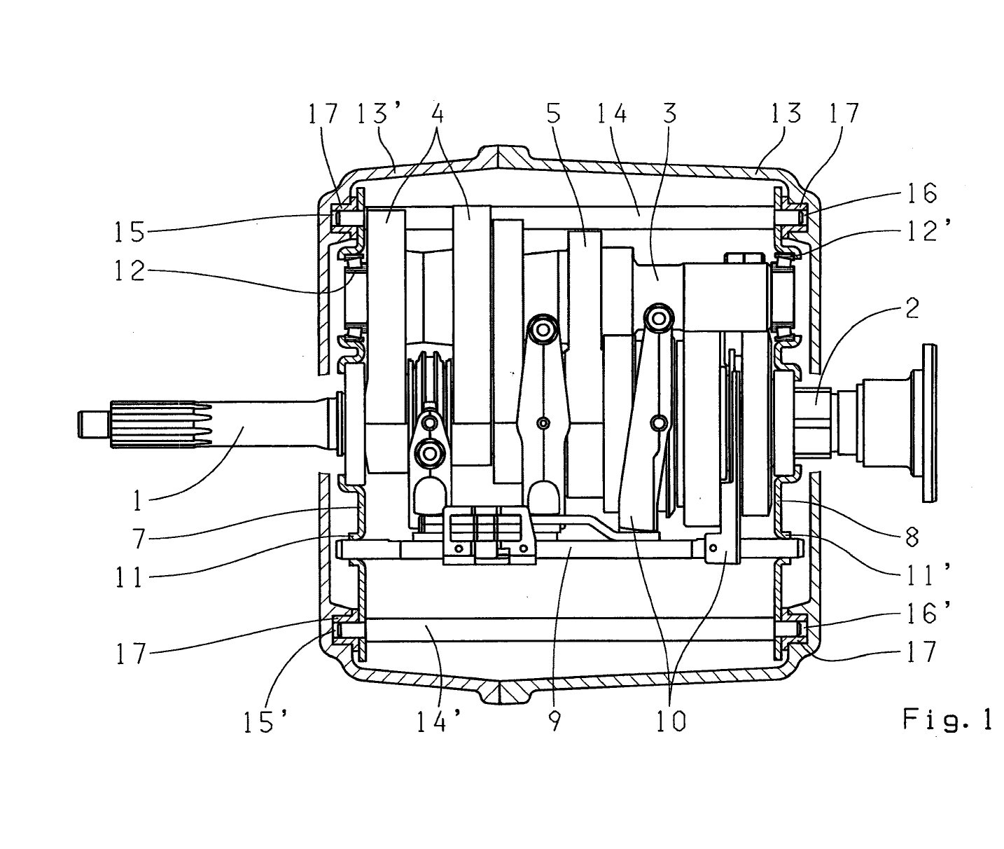

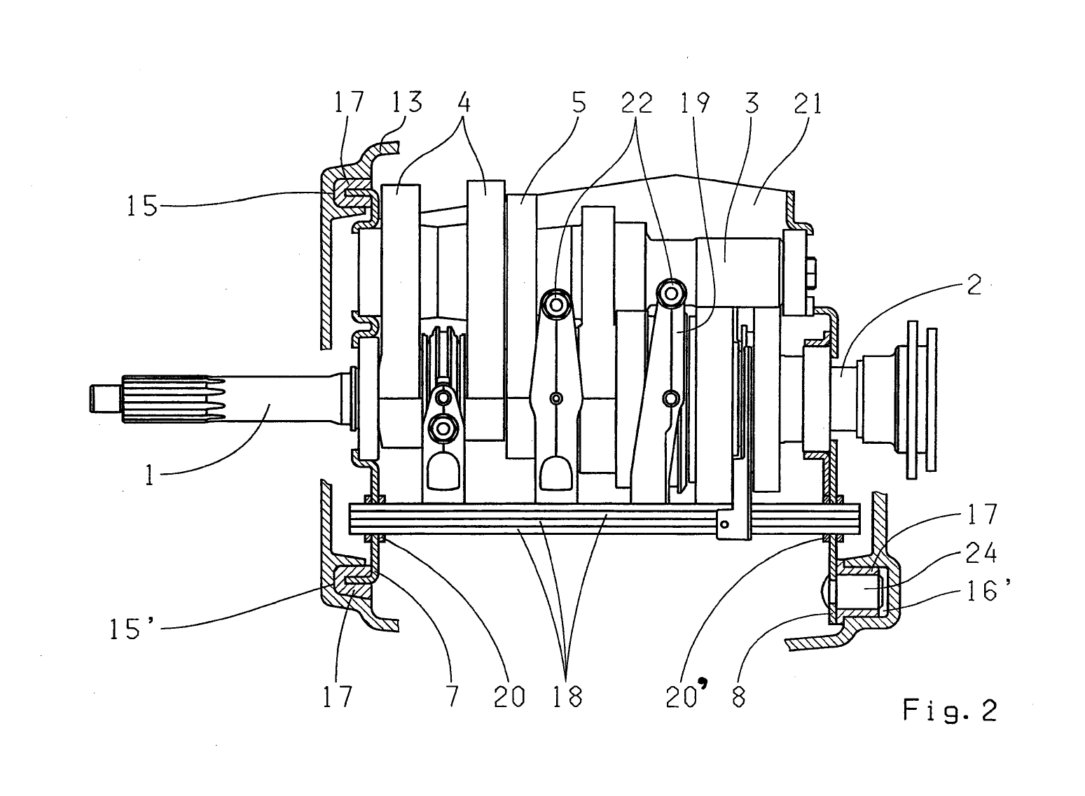

In each of FIGS. 1 and 2, a transmission with a countershaft transmission is schematically as an example. The countershaft transmission features a transmission input shaft 1 that is coupled to a main shaft 2. A countershaft 3 is arranged parallel to the transmission input shaft 1 and the main shaft 2. The countershaft 3 is coupled via two constant wheels 4 to the transmission input shaft. In addition, the countershaft 3 comprises a gearwheel set 5 with a plurality of gearwheels, in order to realize the desired gear ratios between the transmission input shaft 1 and the main shaft 2 or, as the case may be, the transmission output shaft.

The transmission input shaft 1, the main shaft 2, and the countershaft 3 are each mounted on an input-side bearing bracket 7 and an output-side bearing bracket 8. For this purpose, the two bearing brackets 7, 8 are each constructed in the region of the respective bearing positions as bearing carriers for the bearings of the shaft.

In FIG. 1 the mounting of the countershaft 3 is realized by means of a tapered roller bearing 12, 12′. In contrast to the transmission depicted in FIG. 2, an actuation rod 9 with a shift fork 10 attached to it is provided as the shifting device in the case of the transmission depicted in FIG. 1. The actuation rod 9 is movably mounted in the corresponding collets 11, 11′ of the two bearing brackets 7, 8. As a result of the fact that the bearings of the transmission input shaft 1, the main shaft 2, and the countershaft 3 are provided in separate bearing brackets 7, 8, the axial distance between the two bearings is retained. The bearing brackets 7, 8 are received in an elastic manner by the corresponding recesses 15, 15′, 16, 16′ of the housing components 13, 13′ on the input side and the output side of the countershaft transmission. For this purpose, the recesses 15, 15′, 16, 16′ are lined with a damping element 17 that is composed, for example, of elastic material.

In order to absorb the axial force of the transmission input shaft 1, the main shaft 2, and the countershaft 3, the two bearing brackets 7, 8 are connected via connecting elements. In FIG. 1 round rods 14, 14′ are used as connecting elements. These are connected in each case to an upper and a lower end of the previously described recesses 15, 15′; 16, 16′ in the wall of the housing sections 13, 13′. Via the recesses 15, 15′; 16, 16′ which are each lined with the damping element 17, both the bearing brackets 7, 8 and the ends of the round rods 14, 14′ are decoupled from the housing sections 13, 13′. Because the shifting element with its actuation rod 9 is also held by the bearing brackets 7, 8, the shifting device is also decoupled from the housing sections 13, 13′. An elastic material with damping characteristics is used as a damping element 17.

In addition, not only is there a prevention of longitudinal expansion between the housing sections 13, 13′ which are made, for example, of aluminum and the shafts 1, 2, 3 which are made of steel, but also, due to the elastic mounting in all three axial directions, the load alternation that can lead to axial displacement is also dampened. The round rods 14, 14′ can be adjustable for length, in order to adjust the bearing position of the mountings of the transmission input shaft 1, the main shaft 2, and the countershaft.

In this way complete decoupling of the transmission prevents noise and vibration of the gearwheel set 5 from the countershaft transmission to the housing sections 13, 13′ via the bearings and the shifting device.

In contrast to FIG. 1, FIG. 2 depicts another shifting device. The shifting device depicted in FIG. 2 comprises shift rails 18 that are actuated by shift levers in a known manner, in order to realize desired gear ratios in the transmission. The ends of the shift rails 18 are displaceably mounted on the bearing brackets 7, 8. Sliding guides 20, 20′ are provided for this purpose. The shift levers 19 are retained by the connecting element for the connection of the two bearing brackets 7, 8. A plate 21 is used as a connecting element in the embodiment shown in FIG. 2. The shift levers 19 are rotatably mounted by means of hexagon bolts 22 which are screwed into the plate 21 so that the hexagon bolts 22 form the pivotal point for the levers 19.

The two bearing brackets 7, 8 are curved at the ends so that the curved ends are held respectively in the recesses 15, 15′; 16, 16′ in the wall of the housing 13. For this purpose, the recesses 15, 15′; 16, 16′ also contain the damping element 17. In order to center the bearing arrangement in the housing 13, the bearing bracket 8 is fixed inside the recess 16′ of the housing 13 by means of a riveted bolt 24.

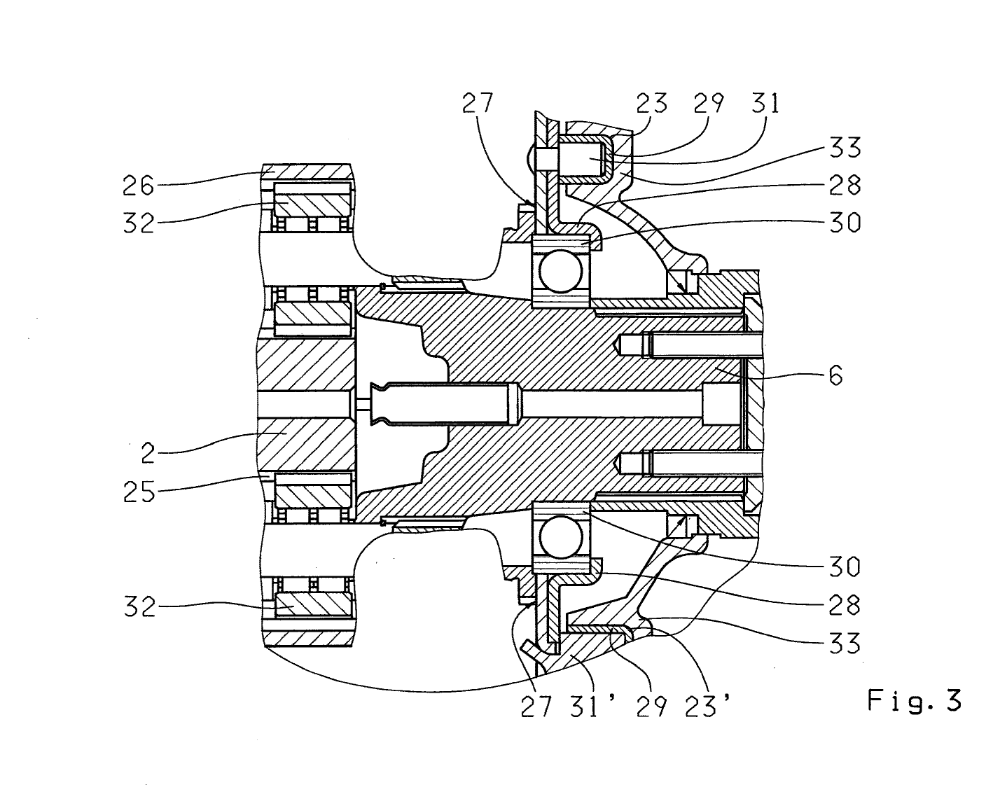

FIG. 3 is a partial view of an output-side bearing of a so-called range transmission. With this arrangement the main shaft 2 is coupled to a range group as a planetary gear train. For this purpose the sun gear 25 is connected to the main shaft 2. The spider shaft or, as the case may be, the planet carrier is formed by the transmission output shaft 6.

In order to realize a gear ratio from the transmission input shaft 1 to the transmission output shaft 6, the ring gear 26 is connected to the housing 33. The ring gear 26 engages the planet gears 32. In order to support this so-called GP reaction on the housing 33, a coupling body 27 is provided as a support point. In the inventive transmission the coupling body 27 is connected with the housing 33 by means of a bearing carrier 28 of the transmission output shaft via an additional damping element 29.

For this purpose, the bearing carrier 28 of the roller bearing 30 of the transmission output shaft 6 is attached to the coupling body 27 of the GP reaction by means of retaining bolts 31, 31′ in the associated retaining collet 23, 23′ of the housing 33. Each retaining collet 23, 23′ is lined with the additional damping element 29, in order to enable complete decoupling of the output-side bearing of the transmission output shaft 6, as well as the range group that is also coupled to the main shaft 2. The damping element 29 is also made of an elastic material or similar.

### REFERENCE CHARACTERS

1 Transmission input shaft
2 Main shaft
3 Countershaft
4 Constant wheels
5 Gearwheel set
6 Transmission output shaft
7 Input-side bearing bracket
8 Output-side bearing bracket
9 Actuating rod
10 Shift fork
11, 11′ Collet
12, 12′ Tapered roller bearing
13, 13′ Housing, housing section
14, 14′ Round rod
15, 15′ Recess
16, 16′ Recess
17 Damping element
18 Shift rail
19 Shift lever
20, 20′ Sliding guide
21 Plate
22 Hexagon bolt
23, 23′ Retaining collet
24 Bolt
25 Sun gear
26 Ring gear
27 Coupling body
28 Bearing carrier
29 Additional damping element
30 Roller bearing
31, 31′ Retaining bolt
32 Planet gears
33 Housing

1-16. (canceled)

17. A transmission having a housing (13, 13′, 33) in which at least first and second shafts (1, 2), for adjusting a desired gear ratio, are coupled by a gearwheel set,
the first and the second shafts (1, 2) being mounted by bearing brackets (7, 8) inside the housing (13, 13′, 33), and
the bearing brackets (7, 8) being mounted by at least one damping element (17) for damping noise and vibration of the housing (13, 13′, 33), and
a shifting device, which adjusts the gear ratio, being affixed to at least one of the bearing brackets which is decoupled from the housing (13, 13′, 33).

18. The transmission according to claim 17, wherein the shifting device comprises an actuating rod (9) for actuating at least one shift fork (10), and each end of the actuating rod (9) is movably deposed on an assigned bearing bracket (7, 8).

19. The transmission according to claim 18, wherein the shifting device comprises a plurality of shift rails (18) for actuating shift levers (19), and each end of the shift levers (18) is displaceably deposed on the assigned bearing bracket (7, 8).

20. The transmission according to claim 17, wherein the two bearing brackets (7, 8) are connected, in an axial direction of the first and the second shafts (1, 2), by at least one shift element.

21. The transmission according to claim 20, wherein at least one of a round rod (14, 14′) and a plate (21) is provided as a connecting element.

22. The transmission according to claim 21, wherein the shift levers (19) of the shifting device are rotateably deposed on the disc (21).

23. The transmission according to claim 22, wherein the shift levers (19) are connected by a bolt (22) that is provided as a swiveling axis which is connected to the disc (21).

24. The transmission according to claim 23, wherein the bolt (22) is a hexagon bolt (22) and is screwed to the plate (21).

25. The transmission according to claim 21, wherein the connecting elements are longitudinally adjustable.

26. The transmission according to claim 21, wherein each round rod (14, 14′) is affixed at each end inside recesses (15, 15′; 16, 16′) of the housing (13, 13′, 33) that is lined with one of the damping elements (17).

27. The transmission according to claim 17, wherein at least one transmission input shaft (1), at least one countershaft (3), a main shaft (2), and an assigned shifting device are deposed vertically above the decoupled bearing bracket (7, 8).

28. The transmission according to claim 17, wherein a transmission output shaft (6), with a coupled range group, is decoupled by at least one additional damping element (29) for damping noise and vibration from the housing (33).

29. The transmission according to claim 28, wherein a supporting point of the reaction of the range group and a bearing carrier (28) of the transmission output shaft (6) are each attached to the housing (33) by the damping element (29).

30. The transmission according to claim 28, wherein a coupling body (27), as a supporting point, and the bearing carrier (28) are inside an associated retaining collet (23,23′) of the housing (33) attached by retaining bolts (31).

31. The transmission according to claim 30, wherein each retaining collet (23, 23′) is lined with the damping element (29).

32. The transmission according to claim 30, wherein each retaining bolt (31, 31′) is riveted into the assigned retaining collet (23, 23′).
